(19) United States
(12) Patent Application Publication
(10) Pub. No.: US 2014/0156978 A1
(43) Pub. Date: Jun. 5, 2014

(54) Detecting and Filtering Biased Branches in Global Branch History

(71) Applicants: Muawya M. AL-OTOOM, Beaverton, OR (US); Paul CAPRIOLI, Hillsboro, OR (US); Jeffrey J. COOK, Portland, OR (US)

(72) Inventors: Muawya M. AL-OTOOM, Beaverton, OR (US); Paul CAPRIOLI, Hillsboro, OR (US); Jeffrey J. COOK, Portland, OR (US)

(21) Appl. No.: 13/691,049

(22) Filed: Nov. 30, 2012

(51) Int. Cl. G06F 9/38

(52) U.S. Cl. CPC G06F 9/38
USPC 712/240

(57) ABSTRACT

A processor includes an instruction pipeline for executing instructions including a branching instruction, a counter for counting times that the branching instruction is taken, a register for storing a global branch history as a function of a value of the counter, and a branch prediction unit for predicting branching based on the global branch history.

### FIELD OF THE INVENTION

The present disclosure pertains to branch prediction in a processor, in particular, to systems and methods for generating a global branch history that is free of biased branches.

### BACKGROUND

Hardware processors may include one or more processing cores. Each of the processing cores may include an instruction processing pipeline for executing instructions or micro-operations. A sequence of instructions may include branching instructions such as loops or condition instructions. To increase the speed of instruction execution, the processing core may include a branch prediction unit which is a circuit that may predict what will occur at branching instructions based on a history of instruction execution. Based on the prediction, the processing pipeline may pre-fetch the predicted instructions or micro-operations and execute the pre-fetched instructions. While correct branch prediction may enhance the processor performance, incorrect branch prediction may incur a performance penalty. Thus, it is desirable that the branch prediction unit makes correct predictions of which direction the branching instructions will take.

The accuracy of the branch prediction depends, in part, on the history of retired instructions or micro-operations, or those that had executed. The history of instruction execution may be, as a whole, called global branch history and recorded in a register as the execution of instructions and micro-operations occur. The branch prediction unit may read from the history register and based on the global branch history, predict the directions of branching instructions. Thus, the global branch history is used to dynamically predict the direction of conditional branches at fetch time. The global branch history provides a history of the directions that a plurality of retired instructions previously took. This history may provide guidance to the likely directions of the current branch.

Unfortunately, the global branch history may be biased or dominated by certain highly repetitive loops. Table 1 is a segment of a common C program that may be used to illustrate this bias.

TABLE 1

```
for (i = 0; i < 1000; i++) {
  if (a[j] >= 3)
    m++;
  else
    n++;
}
```

The program as shown in Table 1 includes a loop (the for command) that further includes a conditional branching instruction (the if-else command) within the loop. In this example, the loop condition is mostly taken (i.e., 999 out of 1000 times). This may be further illustrated by the specific example as shown in FIG. 2. In reference to the segment of programs of Table 1, a[i] 202 is an array that may take on values as shown. The global branch history register may sequentially store values indicating a branch is taken or not. In this example, the “for” loop traverses each value stored in the array a[i] and the “if” instruction to test the values stored in a[i] against the value 3. Each bit of the global branch history register 204 may store an indicator which indicates whether a branch is taken (T) or not taken (N). In the example of FIG. 2, the loop branch and the conditional branch are both stored in the global branch history register 204. The content of the global branch history register at the even positions corresponds to the content of a[i]. Thus, at positions 0, 2, 4, 6, 8, 10, 12, 14 of the global branch history register 204 record the branching of the “for” loop, and at positions 1, 3, 5, 7, 9, 11, 13, 15 of the global branch history register 204 record the branching of the “if” condition.

The branch prediction unit may use a number of previous directions (including those of “for” and “if” branching instructions) to predict the current branching direction. For example, as shown in FIG. 2, the branch prediction unit uses 16 previous history values to predict whether the next branch will be taken. Since both outcomes of the “for” branch and the “if” branch are pushed into the global branch history register, and the “for” branch is almost always taken. However, the global branch history is biased because the “for” branch is almost always taken (99.9% times) and does not contribute any useful information. This bias is detrimental to the prediction of the “if” branch.

### DESCRIPTION OF THE FIGURES

Embodiments are illustrated by way of example and not limitation in the Figures of the accompanying drawings:

FIG. 1 is a block diagram of a system according to one embodiment of the present invention.

FIG. 2 illustrates branching prediction based on a global branch history.

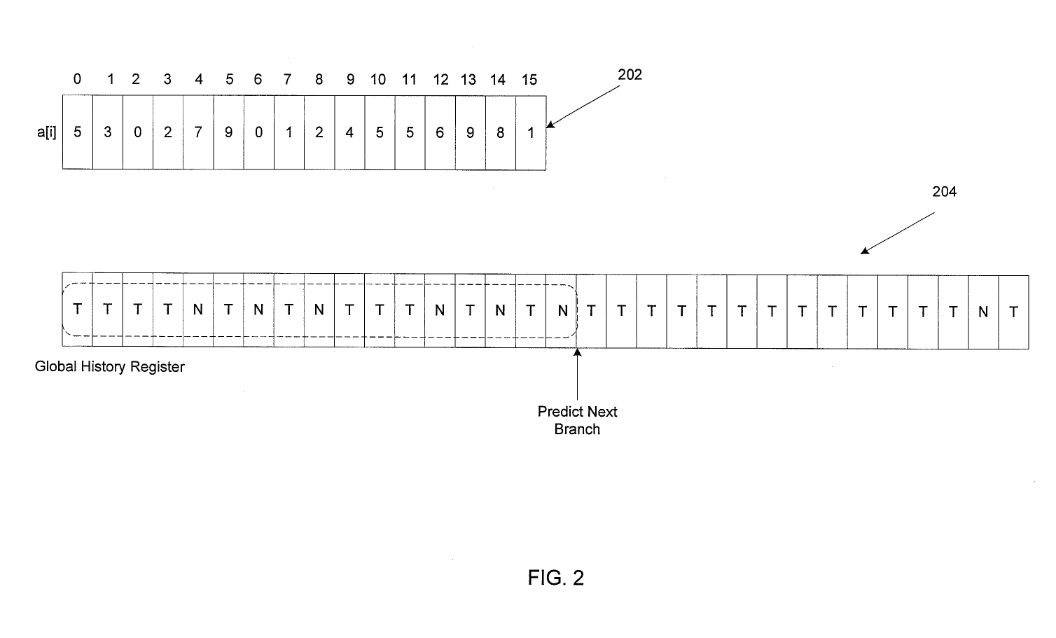

FIG. 3 is a processing core according to another embodiment of the present invention.

FIG. 4 is a branch bias table according to an embodiment of the present invention.

FIG. 5 is a process for determining whether a branching instruction is biased according to an embodiment of the present invention.

### DETAILED DESCRIPTION

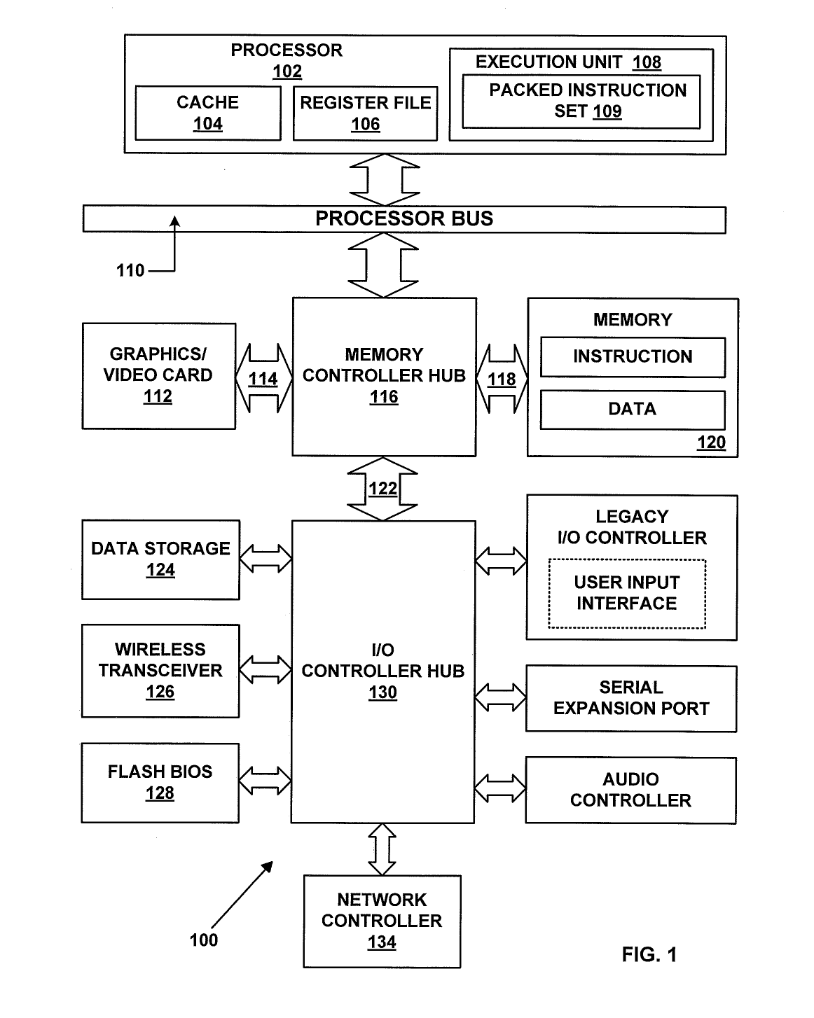

FIG. 1 is a block diagram of a computer system 100 formed with a processor 102 that includes one or more execution units 108 to perform an algorithm to perform at least one instruction in accordance with one embodiment of the present invention. One embodiment may be described in the context of a single processor desktop or server system, but alternative embodiments can be included in a multiprocessor system. System 100 is an example of a ‘hub’ system architecture. The computer system 100 includes a processor 102 to process data signals. The processor 102 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that can transmit data signals between the processor 102 and other components in the system 100. The elements of system 100 perform their conventional functions that are well known to those familiar with the art.

In one embodiment, the processor 102 includes a Level 1 (L1) internal cache memory 104. Depending on the architecture, the processor 102 can have a single internal cache or multiple levels of internal cache. Alternatively, in another embodiment, the cache memory can reside external to the processor 102. Other embodiments can also include a combination of both internal and external caches depending on the particular implementation and needs. Register file 106 can store different types of data in various registers including integer registers, floating point registers, status registers, and instruction pointer register.

Execution unit 108, including logic to perform integer and floating point operations, also resides in the processor 102. The processor 102 also includes a microcode (ucode) ROM that stores microcode for certain macroinstructions. For one embodiment, execution unit 108 includes logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications can be accelerated and executed more efficiently by using the full width of a processor's data bus for performing operations on packed data. This can eliminate the need to transfer smaller units of data across the processor's data bus to perform one or more operations one data element at a time.

Alternate embodiments of an execution unit 108 can also be used in micro controllers, embedded processors, graphics devices, DSPs, and other types of logic circuits. System 100 includes a memory 120. Memory 120 can be a dynamic random access memory (DRAM) device, a static random access memory (SRAM) device, flash memory device, or other memory device. Memory 120 can store instructions and/or data represented by data signals that can be executed by the processor 102.

A system logic chip 116 is coupled to the processor bus 110 and memory 120. The system logic chip 116 in the illustrated embodiment is a memory controller hub (MCH). The processor 102 can communicate to the MCH 116 via a processor bus 110. The MCH 116 provides a high bandwidth memory path 118 to memory 120 for instruction and data storage and for storage of graphics commands, data and textures. The MCH 116 is to direct data signals between the processor 102, memory 120, and other components in the system 100 and to bridge the data signals between processor bus 110, memory 120, and system I/O 122. In some embodiments, the system logic chip 116 can provide a graphics port for coupling to a graphics controller 112. The MCH 116 is coupled to memory 120 through a memory interface 118. The graphics card 112 is coupled to the MCH 116 through an Accelerated Graphics Port (AGP) interconnect 114.

System 100 uses a proprietary hub interface bus 122 to couple the MCH 116 to the I/O controller hub (ICH) 130. The ICH 130 provides direct connections to some I/O devices via a local I/O bus. The local I/O bus is a high-speed I/O bus for connecting peripherals to the memory 120, chipset, and processor 102. Some examples are the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. The data storage device 124 can comprise a hard disk drive, a floppy disk drive, a CD-ROM device, a flash memory device, or other mass storage device.

For another embodiment of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

Embodiments of the present invention may include a processor that includes an instruction pipeline for executing instructions including a branching instruction, a counter for counting times that the branching instruction is taken, a register for storing a global branch history as a function of a value of the counter, and a branch prediction unit for predicting branching based on the global branch history.

Embodiments of the present invention may include a processor that includes a plurality of processing cores. Each of the processing cores may include an instruction pipeline for executing instructions including a plurality of branching instructions, a first register including a plurality of counters, each of the plurality of counters counting respective times that the plurality of branching instructions are taken or not, a second register for storing a global branch history as a function of a value of the plurality of counters, and a branch prediction unit for predicting branching based on the global branch history.

Embodiments of the present invention may include an instruction pipeline for executing instructions including a branching instruction, a first register including bits as bias indicators set by dedicated hardware circuitry, firmware layer, operating system, compiler, or a combination thereof, each bias indicator indicating whether a branching instruction is biased or not, a second register for storing a global branch history that is recorded as a function of the bias indicators, and a branch prediction unit for predicting branching based on the global branch history.

Realizing the detrimental effects of biased global branch history, previously, a plethora of methods have been employed to address the pollution to the prediction. For example, agree predictor, skewed predictor, or TAGE predictor may be used to correct the effect of the biased global branch history. However, these predictors merely correct the ill effects after the global branch history has been polluted by the bias, rather than addressing the pollution before it occurs. Additionally, when the storage for the global branch history is limited (such as a limited length register), the biased branch takes valuable resources from useful information.

Embodiments of the present invention provide apparatus and methods for keeping bias from being stored in a global branch history. In particular, embodiments of the present invention may determine whether the branching instruction occurring at a specific instruction pointer (IP) is biased or not, and record the branching in the global branch history only if the branching is determined not biased. In this way, the global branch history may be pre-filtered to remove bias. Embodiments of the present invention may prevent results from highly biased branches from entering the global branch history.

In one embodiment of the present invention, the dedicated hardware circuitry, firmware layer, operating system (OS), compiler, or a combination thereof, of a computer system may be configured to perform the pre-filter of bias. The OS may be programmed to include a component that may identify whether a branching instruction in a program is biased or not. A branching instruction is biased if it is almost always “taken” or if it is almost always “not taken.” In practice, the branch is labeled as biased if the “taken” percentage (or “not taken” percentage) is higher than a pre-specified threshold for a pre-specified numbers of invocation of the branching instruction. For example, the pre-specified percentage may be set at 95%, 98%, or 99% of “taken” (or “not taken”) for 16 times of invocation of a branching instruction so that if percentage of “taken” (or “not taken”) is higher than the set percentage, the branching instruction is considered biased. Upon identifying that a branching instruction is biased towards “taken” (or, “not taken”), the dedicated hardware circuitry, firmware layer, operating system, compiler, or a combination thereof, may set an indicator assigned to the branching instruction to indicate that the branching instruction is biased.

In one embodiment, a register may be used to indicate bias status for branching instructions. For example, the register may include a plurality of bits, each of the plurality of bits may indicate the bias status for a specific branching instruction. In one embodiment, the bit may set to “1” to indicate a bias, and “0” to indicate no bias. Therefore, after executing the code (pointed to by an instruction pointer) representing a branching instruction, the processor may first check the bias indicator to determine if the branching instruction is biased. If the branching instruction is biased, the processor may not push the result at the branching instruction into the global branch history. In this way, the global branch history may not be polluted by biased branching instructions.

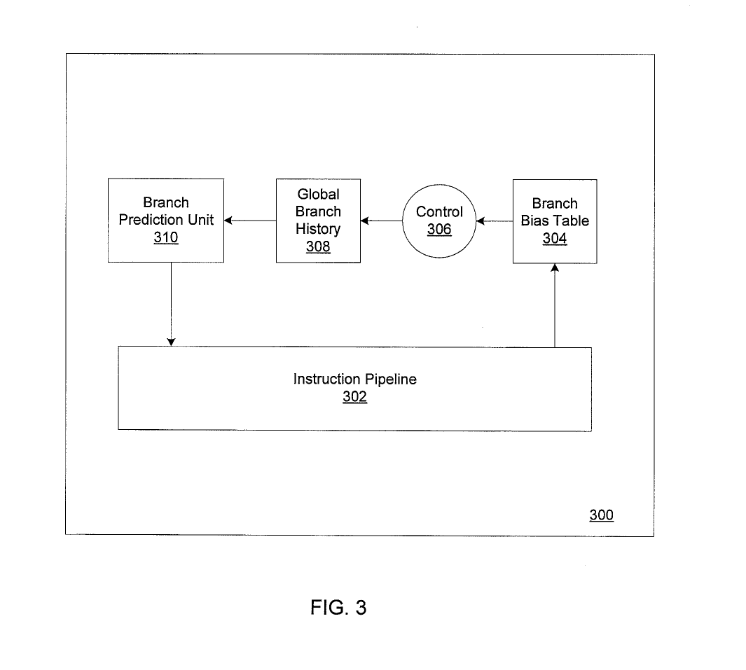

In another embodiment, hardware components may be used to determine which branching instructions are biased and to prevent the results of the biased branching instructions from entering the global branch history. FIG. 3 is a processor core that may determine biased branching instructions according to an embodiment of the present invention. As shown in FIG. 3, a processor core 300 may include an instruction execution pipeline 302, a first register 304 having stored thereon a branch bias table, a controller 306, a second register 308 having stored thereon a global branch history, and a branch prediction unit 310. The instruction execution pipeline 302 may include circuitries for executing instructions including branching instructions (such as “if” and “for” commands as shown in Table 1). Each branching instruction may be indexed by an instruction pointer (IP).

The branch bias table 304 may include a plurality of counters, each of the counters corresponding to one respective branching instruction pointer designated by an instruction. Each counter may include a value that may change in accordance with whether the corresponding branching instruction is taken or not taken. The value of the counter may indicate whether the corresponding branching instruction is biased or not.

Controller 306 may determine whether a branching instruction is biased or not based on the value of the counter. If controller 306, based on the value of the counter, determines that the corresponding branching instruction is not biased either towards “taken” or “not taken, controller 306 may enter the results (“taken” or “not taken”) of the branching instruction to the global branch history 308. However, on the other hand, if controller 306 determines that the branching instruction is biased, controller 308 may not allow the results of the branching instruction to be entered into the global branch history 306. In this way, the global branch history 308 may be free of results from biased branching instructions. Further, branch prediction unit 310 may read from global branch history 308 and based on the history, predict future branching instruction may be “taken” or “not taken.” Since global branch history 308 is free of pollution from biased branching instructions, branch prediction unit 310 may predict more accurately which instructions to pre-fetch based on the global branch history 308.

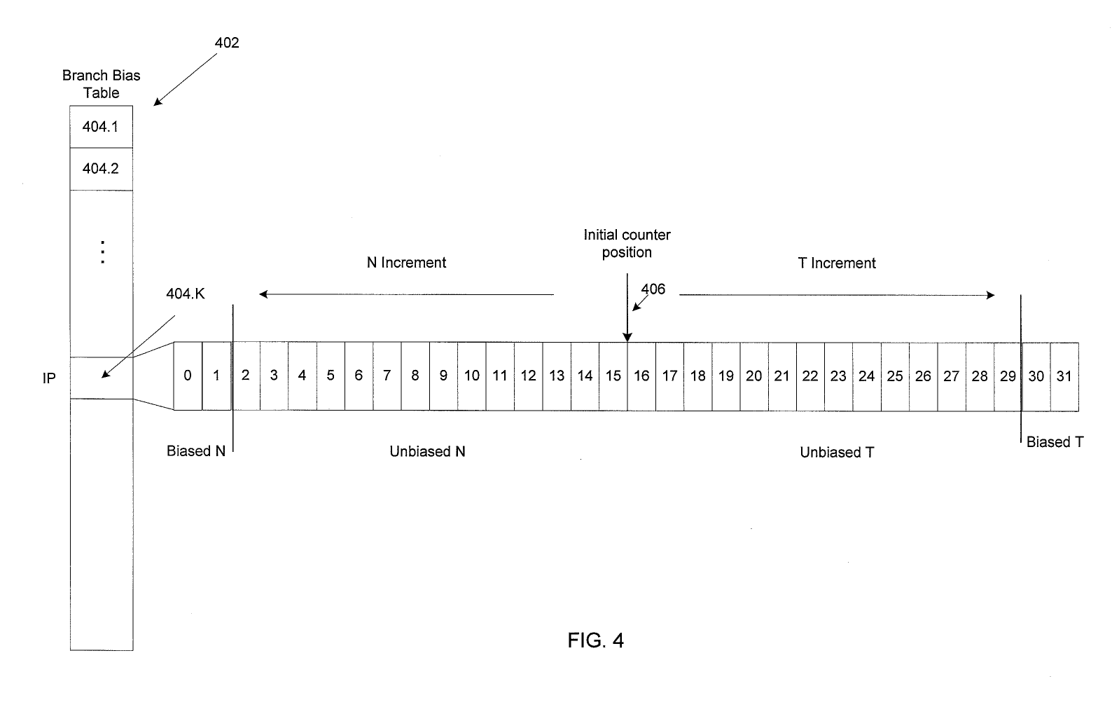

FIG. 4 is a branch bias table 402 according to an embodiment of the present invention. In one embodiment, branch bias table 402 may be stored in a register of a processor core. Alternatively, branch bias table 402 may be stored in a memory that is coupled to the processor core. As shown in FIG. 4, branch bias table 402 may include a number of counters 404.1, 404.2, . . . , 404.K . . . whose values may indicate the bias status. Each counter may be associated with one respective branching instruction and may be indexed according to the instruction pointer (IP) of the branching instruction. Each counter may include a plurality of bits and a counter position pointer 406 which may point to a current counter count. In one embodiment, each counter may count how many times the corresponding branching instruction is “taken” or “not taken.” For example, as shown in FIG. 4, a counter may include a number of bits (such as 5 bits with a maximum value of 32 in this example) with an initial value of 15 to indicate a neutral position. Subsequently, each time the branching instruction is taken, the counter may count the “taken” by incrementing the counter value by one, and each time the branching instruction is not taken, the counter may count the “not taken” by decrementing the counter value by one. In this way, the position of counter position pointer 406 may indicate the retired “taken” vs. “not taken” ratio for a specific branching instruction. A counter value that is larger than the neutral position (or 15) indicates more retired “taken” than retired “not taken” for the branching instruction. On the other hand, a counter position pointer 406 that is smaller than the neutral position indicates more retired “not taken” than retired “taken.”

In one embodiment, a branching instruction is considered “biased” if the counter position pointer 406 is at either the maximum value (or equals to 31 for FIG. 4) or the minimum value (or equals to 0 for FIG. 4). So, the corresponding branching instruction is considered biased, and any further results of the biased branching instruction may not be entered into the global branch history to prevent the biased branching instruction from polluting the history.

Biased branching instruction may intermittently change branch directions. For example, as shown in Table 1, the “for” branching instruction may change direction every 1000 times of loop. To prevent against intermittent changes from affecting the bias status, in another embodiment of the present invention, the bias status may be defined as when the counter value is outside an “un-bias” range. For example, as shown in FIG. 4, the un-bias range may be defined as from 2 to 29. Thus, if the counter value is above the range (or, equals to 30 or 31), the corresponding branching instruction is considered biased towards “taken,” and if the counter value is below the range (or, equals to 0 or 1), the corresponding branching instruction is considered biased towards “not taken.” In this way, the bias status of the branching instruction may not be affected by intermittent change of direction by the branching instruction. For example, the “for” loop as shown in Table 1 may be considered biased towards “taken,” pointing when counter value equals 31. However, when i=1000, the branching instruction may change direction for one time to “not taken” so that the counter value may decrement by one from 31 to 30. Since value 30 is still outside the un-bias range, the bias status of the branching instruction does not change and is still “biased.”

Embodiments of the present invention may be particularly advantageous where the register used for storing the global branching history has only limited length. In such design, filtering biased global branch history may make a big difference.

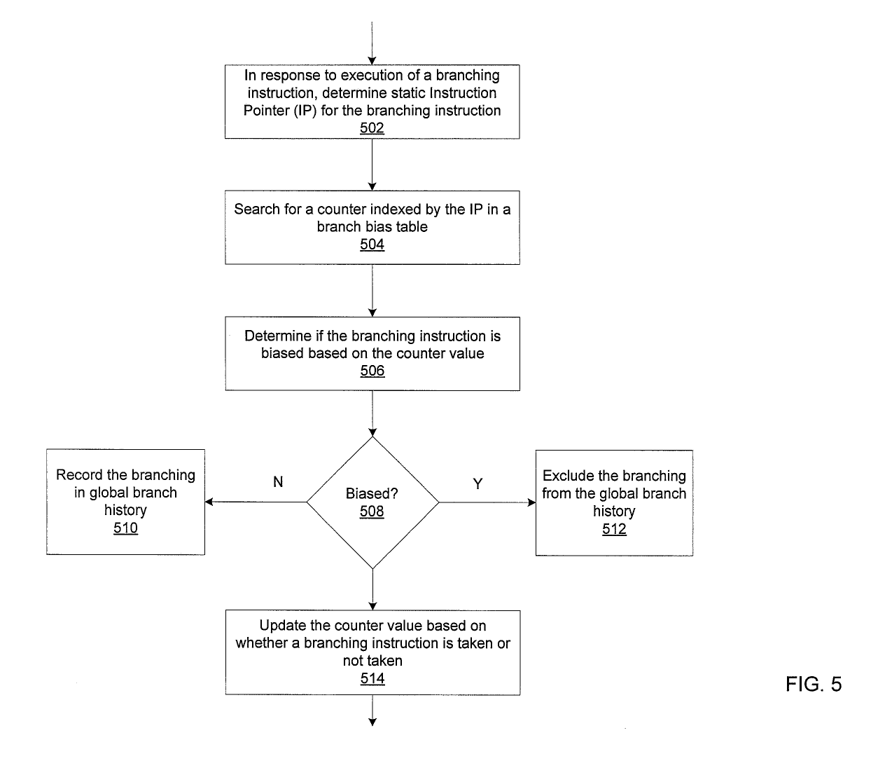

FIG. 5 is a process of using a branch bias table for preventing biased branching instruction from entering a global branch history according to an embodiment of the present invention. At 502, in response to the execution of a branching instruction, a processor may be configured to determine a static instruction pointer (IP) at which the branching instruction is stored. Based on the IP, at 504, the processor may be configured to search a branch bias table stored in a register for a counter indexed by the IP. The counter may include an accumulated value that indicates whether the branch instruction at the IP is biased. At 506, the processor may be configured to determine if the branching instruction is biased based on the counter value. In one embodiment, the branching instruction is considered biased if the counter value is at its maximum or minimum. In another embodiment, the branching instruction is considered biased if the counter value is outside a range. For example, for a branch bias table of 5 bits, the range may be from 2 to 29. Any counter value within the range is considered unbiased, and values outside the range is considered biased.

At 508, if the branching instruction is determined unbiased, the processor may be configured to execute step 510. At 510, the processor may be configured to record the branching in the global branch history. If the branching instruction is determined biased, the processor may be configured to execute step 512. At 512, the processor may be configured to exclude the branching instruction from the global branch history. Thereafter, at 514, the processor may be configured to update the counter value based on whether a branching instruction is taken or not taken. If the branching instruction is “taken,” the counter may increment its value by one (or alternatively, decrement by one), and if the branching instruction is “not taken,” the counter may decrement its value by one (or alternatively, increment by one).

Embodiments of the present invention are not limited to global-history-based branch prediction, and may be applied to other types of predictors. For example, embodiments of the present invention may be applied to the path-based predictors like the L-TAGE predictor.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor, comprising:
an instruction pipeline to execute instructions including a branching instruction;
a counter to count a number of times that the branching instruction is taken;
a register to store a global branch history as a function of a value of the counter; and
a branch prediction unit to predict branching based on the global branch history.

2. The processor of claim 1, wherein the counter is start counting with an initial value.

3. The processor of claim 1, wherein the counter has a limited length.

4. The processor of claim 3, wherein each time the branching instruction is taken, the value of the counter is to be incremented by one, and each time the branching instruction is not taken, the value of the counter is decremented by one.

5. The processor of claim 4, wherein the branching instruction is considered biased if the value of the counter equals one of a maximum value and a minimum value of the counter.

6. The processor of claim 4, wherein the branching instruction is biased if the value of the counter is outside a range.

7. The processor of claim 6, wherein the global branch history is to record results of the branching instruction only if the branching instruction is not biased.

8. The processor of claim 5, wherein the global branch history is to record results of the branching instruction only if the branching instruction is not biased.

9. The processor of claim 5, wherein the global branch history is not to record results of the branching instruction if the branching instruction is biased.

10. The processor of claim 1, further comprising a controller that is coupled to the counter and the register for determining whether the branching instruction is biased based on the value of the counter.

11. A processor, comprising:
a plurality of processing cores, each processing core including:
an instruction pipeline to execute instructions including a plurality of branching instructions;
a first register including a plurality of counters, each of the plurality of counters to count respective times that the plurality of branching instructions are taken or not;
a second register to store a global branch history as a function of a value of the plurality of counters; and
a branch prediction unit to predict branching based on the global branch history.

12. The processor of claim 11, wherein each of the plurality of counters has a limited length.

13. The processor of claim 11, wherein each of the plurality of counters is to start with an initial value, and wherein each time the corresponding branching instruction is taken, the value of the corresponding counter is incremented by one, and each time the corresponding branching instruction is not taken, the value of the corresponding counter is decremented by one.

14. The processor of claim 13, wherein the corresponding branching instruction is considered biased if the value of the corresponding counter equals one of a maximum value and a minimum value of the counter.

15. The processor of claim 13, wherein the corresponding branching instruction is biased if the value of the counter is outside a range.

16. The processor of claim 15, wherein the global branch history is to record results of the corresponding branching instruction only if the corresponding branching instruction is not biased.

17. The processor of claim 14, wherein the global branch history is to record results of the branching instruction only if the branching instruction is not biased.

18. A system, comprising:
a processor;
a memory to store instructions to be executed by the processor;
the processor including
an instruction pipeline to execute instructions including a branching instruction;
a first register including bits as bias indicators to be set by an operating system, each bias indicator indicating whether a branching instruction is biased or not;
a second register to store a global branch history that is recorded as a function of the bias indicators; and
a branch prediction unit to predict branching based on the global branch history.

19. The system of claim 18, wherein the operating system is to determine whether the branching instruction is biased or not, and wherein the branching instruction is biased if a ratio of the branching instruction being taken versus not taken is higher than a pre-specified threshold.

20. The system of claim 19, wherein a result of the branching instruction is to be recorded in the global branch history only if the corresponding bias indicator does not indicate a bias status.

21. The system of claim 18, wherein the bias indicators are further to be set by at least one of dedicated hardware circuitry, firmware layer, and compiler.

22. A method comprising:
executing instructions in a processor including a branching instruction;
counting with a counter a number of times that the branching instruction is taken during execution;
storing in a register a global branch history as a function of a value of the counter; and
predicting branching with a branch prediction unit based on the global branch history.

23. The method of claim 22, further comprising wherein, incrementing the value of the counter by one each time the branching instruction is taken, and decrementing the value of the counter by one each time the branching instruction is not taken.

24. The method of claim 23, wherein the branching instruction is considered biased if the value of the counter equals one of a maximum value and a minimum value of the counter.

25. The method of claim 24, further comprising recording results of the branching instruction in the global branch history records results only if the branching instruction is not biased.
